(19) United States
(12) Patent Application Publication
(10) Pub. No.: US 2005/0234592 A1
(43) Pub. Date: Oct. 20, 2005

(54) System and method for reconfiguring an autonomous robot

(75) Inventors: Claudia Zinnen McGee, Nevillewood, PA (US); John Thomas Walden, Swissvale, PA (US); Sarjoun Skaff, Pittsburgh, PA (US)

Correspondence Address: WILMER CUTLER PICKERING HALE AND DORR LLP, 399 PARK AVENUE, NEW YORK, NY, 10022, US

(73) Assignee: Mega Robot, Inc.

(21) Appl. No.: 11/036,852

(22) Filed: Jan. 14, 2005

Related U.S. Application Data
(60) Provisional application No. 60/536,516, filed on Jan. 15, 2004.

(51) Int. Cl. G06F 19/00

(52) U.S. Cl. 700/245

(57) ABSTRACT

In accordance with the present invention, systems and methods for reconfiguring an autonomous robot are provided. By using a system interface, the present invention provides an approach for distributing the complex and costly robotic components of the conventional autonomous robots. By distributing these components, users, such as software developers, may develop interactive software for robots without having any understanding of robotics. The present invention includes a processing device, a system interface, and a robot. The processing device at least partially executes an interactive robotic application that is configured to receive an instruction for the robot from a user. In response to receiving the instruction, the instruction is transmitted to the robot control interface. In response, the robot control interface is configured to convert the instruction, to the extent that the instruction is not comprehensible by the robot, to a robot control command that is comprehensible by the robot, and wirelessly transmit the robot control command to the robot. The robot, in response to receiving the robot control command, directs the motors and/or the sensors associated with the robot to execute the robot control command.

### CROSS-REFERENCE TO RELATED APPLICATION

This application claims the benefit under 35 U.S.C. § 119(e) of U.S. Provisional Patent Application No. 60/536,516, filed Jan. 15, 2004, which is hereby incorporated by reference herein in its entirety.

### FIELD OF THE INVENTION

The present invention relates to a system and method for reconfiguring a conventional, autonomous robot. More particularly, the invention relates to a system and method for creating a new robot configuration by coupling software and devices required to run the software with autonomous robots.

### BACKGROUND OF THE INVENTION

Conventional, autonomous robots are comprised of complex mechanical systems, electronic systems and software systems. Each system interacts with the other in a highly interdependent way where complexity in the mechanical systems drives the need for complexity in the electronic systems and in the software systems, and so on.

A conventional robot includes (1) robot application software, which defines the purpose of the robot and directs how the robot accomplishes that purpose, (2) robot operating software, which controls the robot and the mechanisms of which it is comprised, (3) processors that run the robot application software and the robot control software, (4) memory to store the robot application software, the robot control software, and the information collected by the sensors of the robot, (5) mechanisms of the robot, e.g., sensors, actuators, and drive motors, and (6) power.

In a conventional, autonomous robot, the autonomy of the robot is a result of programming that gives the robot some intelligence related to its application. The intelligence of the autonomous robot allows the robot to acquire and process information from its environment, or while performing the task programmed in its application, and to change its behaviors based on that information.

In the field of conventional, autonomous robots, there are robots designed for many different applications. Examples of such applications include industrial applications, like energy and planetary exploration, municipal infrastructure analysis, like the assessment of municipal water systems, hazardous waste clean up, agriculture, mining, and security; service applications such as nursing, drug delivery in hospitals, vacuuming, and lawn care; entertainment and education, like tour guides for museums; and robotic toys, like the Sony Aibo®, a robotic pet-like apparatus available from Sony Corporation.

In the art, there are known applications related to the field of robotics. In those examples, the components of the design of the robot remain fixed within the description above of the conventional, autonomous robot. One prior approach has sought to make the robot control unit and memory unit modular and interchangeable, which allows the robot control unit and the memory unit to be replaced. The modular design, however, does not change the overall configuration of the robot, which has the components of the conventional, autonomous robot described above. The purpose of the interchangeable units in that example is to make it easier to diagnose and solve programming issues in the robotic operating system, further underscoring the complexity of the conventional, autonomous robot.

The complexity of the design of the conventional, autonomous robot has made robots expensive to manufacture and has resulted in economic disequilibrium in the industry. The robotics industry has been successful only on a limited basis in establishing a commercially-viable intersection between robotic functionality and the retail price of robots. The persistent disequilibrium has been a barrier to the creation of mass market robotic applications which, in turn, has been a barrier to the commercialization of new robotic technologies.

The complexity of the design of the conventional, autonomous robot has also limited the interactivity of robotic applications, which in this case means the potential of humans to interact with robots through an interface (e.g., a touch screen, microphone, keyboard, joystick, etc.) and impact the way a robot completes its task as well as the ability of a robot to respond to human commands.

Robot interactivity is limited in the conventional, autonomous robot because the complexity of programming the robot application software and robot control software precludes additional programming for interactivity and, as a result, robotic applications remain task-focused. The processing power for the robot is also a limiting factor for interactivity based on the configuration of the conventional autonomous robot because with the robot application software, the robot control software, and the autonomy related to the application, the processing power is at capacity.

While many examples of representations of what a robot can be exist in popular culture and in scientific writings and while the potential for many of those robots to be developed exists in state-of-the-art robotics, the vision remains unfulfilled because, beyond the most limited examples, the configuration of the conventional, autonomous robot is so complex that robots are not affordable to manufacture and the industry economic model slows advancement outside of the laboratory.

Accordingly, it is desirable to provide systems and methods that overcome these and other deficiencies in the prior art.

### SUMMARY OF THE INVENTION

In accordance with the present invention, systems and methods are provided to make the widespread adoption of robots possible by reducing the complexity and, hence, the cost to manufacture such robots. More particularly, the systems and methods provide hardware and software interfaces that work in concert to create a system for reconfiguring a conventional, autonomous robot and for enabling interactive robotic applications by connecting interactive software, the consumer electronic device that the software is implemented on, and a robot or robots.

The interfaces of the invention distribute the complex robotic components of the conventional, autonomous robot, namely the robot operating software, the robot application software, the processing power and memory requirements for the robot operating software, and robot application software, to other devices and software programs.

The present invention also seeks to increase the interactivity of robots and advance the development of interactive robotic applications by enabling simple robot mechanisms to display complex, interactive behaviors. By distributing the robot application software from the robot to interactive robotic software applications and the devices that run the software and by standardizing robot control, software developers can develop interactive software for robots without having any understanding of robotics. Software developers can then focus on creating imaginative, challenging or educational interactive robotic applications in which an unlimited range of complex scenarios can be written for simple robot mechanisms.

The system of the present invention is configured to be used with multimedia software, although it is not limited in that way, that includes some or all of the following capabilities, namely, text, graphics, animation, audio, still images or video, and that provides a high degree of user control and interactivity, such as video game software and multimedia courseware used for training and simulation applications. The system of the present invention is configured to be used with devices that contain processing power similar to or on the order of that found in a personal computer including, but not limited to, devices for home electronics and communication such as video game consoles, handheld video game devices, personal digital assistants, cell phones, DVD players, TIVO®, personal computers, and distributed processing power via the Internet.

Within the field of robotics, the invention is configured to be used with simple robot mechanisms comprised of sensors, actuators, drive motors, and power to derive the economic benefit of the reconfiguration of the robot but the system of the invention can also be used with conventional, autonomous robots. The invention can be used with robots developed for any application including, but not limited to, robots designed for industrial, service, entertainment, education, and toy applications.

In accordance with the present invention, systems and methods are provided for reconfiguring an autonomous robot.

By using a system interface, the present invention provides an approach for distributing the complex and costly robotic components of the conventional autonomous robots. By distributing these components (e.g., the robot application software), users, such as software developers, may develop interactive software for robots without having any understanding of robotics.

In accordance with some embodiments of the present invention, systems and methods for controlling a reconfigured robot are provided. The system includes a processing device, a robot control interface, and a robot. The processing device has a first interface that is in communications with the robot control interface. The processing device may also include memory and a processor, where the processor is at least partially executing an interactive robotic application. The interactive robotic application may be configured to receive an instruction for the robot from a user. In response to receiving the instruction, the interactive robotic application may transmit the instruction to the system interface.

The robot control interface may also include memory, a first wireless communications module, and a processor. The processor on the system interface may at least partially execute a robot control application that is configured to receive the instruction from the interactive robotic application, convert the instruction to a robot control command, and transmit the robot control command to a robot using the first wireless communications module.

In some embodiments, the robot control application on the robot control interface is further configured to determine the at least one robot control command based at least in part on the received sensor data.

In some embodiments, the robot control command is comprehensible by the robot, while the received instruction is not comprehensible by the robot. In particular, the robot control interface may determine whether the instruction is comprehensible by the robot. To the extent that the instruction is not comprehensible by the robot, the robot control interface converts the instruction to a robot control command.

The robot may include a second interface that is in communications with the system interface, one or more sensors that transmit sensor data to the second interface, and one or more motors. The second interface may transmit sensor data to the system interface using the second wireless communications module, receive the robot control command from the system interface, and direct the motors and/or the sensors to execute the robot control command.

Under another aspect of the present invention, the first interface may reside on the robot control interface.

Under another aspect of the present invention, the robot control interface may reside on the processing device along with the first interface. In some embodiments, the robot control interface does not include a processor and memory and operates as a relay between the first interface of the processing device and the second interface of the robot.

Under another aspect of the present invention, the system may include robot models. In some embodiments, the robot models are provided on the first interface. Alternatively, the robot models may be provided on the robot control interface having memory and a processor, on a combined first interface and robot control interface, or on the robot.

Thus, there has been outlined, rather broadly, the more important features of the invention in order that the detailed description thereof that follows may be better understood, and in order that the present contribution to the art may be better appreciated. There are, of course, additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and description matter in which there is illustrated preferred embodiments of the invention.

### BRIEF DESCRIPTION OF THE DRAWINGS

Various objects, features, and advantages of the present invention can be more fully appreciated with reference to the following detailed description of the invention when considered in connection with the following drawings, in which like reference numerals identify like elements.

FIG. 1A is a simplified block diagram showing the system of the present invention that includes interactive software, a consumer electronic device, and a robot in accordance with some embodiments of the present invention.

FIG. 1B is a detailed example of the robot operating system, the robot control interface, and the robot control board of FIG. 1A that may be used in accordance with some embodiments of the present invention.

FIG. 2 is a block diagram depicting the elements of a conventional, autonomous, robot.

FIGS. 3-6 are block diagrams illustrating exemplary embodiments of how the system of the present invention enables the conventional, autonomous robot to be reconfigured in accordance with some embodiments of the present invention.

FIG. 7 is an exemplary block diagram showing the system of the present invention in context with video game software, a video game console and a robot in accordance with some embodiments of the present invention.

### DETAILED DESCRIPTION OF THE PREFERRED EMBODIMENTS

In the following detailed description, numerous specific details are set forth regarding the system and method of the present invention and the environment in which the system and method may operate, etc., in order to provide a thorough understanding of the present invention. It will be apparent, however, to one skilled in the art that the present invention may be practiced without such specific details. In other instances, well-known components, structures and techniques have not been shown in detail to avoid unnecessarily obscuring the subject matter of the present invention. Moreover, various examples are provided to explain the operation of the present invention. It should be understood that these examples are exemplary. It is contemplated that there are other methods and systems that are within the scope of the present invention.

In accordance with the present invention, systems and methods are provided to make the widespread adoption of robots possible by reducing the complexity and, hence, the cost to manufacture such robots. More particularly, the systems and methods provide hardware and software interfaces such that it is possible to reconfigure the design of the conventional, autonomous robot by coupling software with the devices required to run the software and the robots.

The interfaces of the invention distribute the complex robotic components of the conventional, autonomous robot, namely the robot operating software, the robot application software, the processing power and memory requirements for the robot operating software, and robot application software, to other devices and software programs.

The present invention also seeks to increase the interactivity of robots and advance the development of interactive robotic applications by enabling simple robot mechanisms to display complex, interactive behaviors. By distributing the robot application software from the robot to interactive robotic software applications and the devices that run the software and by standardizing robot control, software developers can develop interactive software for robots without having any understanding of robotics. Software developers can then focus on creating imaginative, challenging or educational interactive robotic applications in which an unlimited range of complex scenarios can be written for simple robot mechanisms.

Some embodiments of the present invention are directed to a system for reconfiguring a conventional, autonomous robot using an interactive robotic software application. The system may comprise a Robot Control Interface, a first interface coupled to the Robot Control Interface and the interactive robotic software application, where the first interface translates and communicates high-level software commands received from the interactive robotic software application to the Robot Control Interface and a second interface coupled to the first interface by the Robot Control Interface, where the second interface provides wireless communication between a robot and the Robot Control Interface to allow for receipt of commands for robot control by the robot from the Robot Control Interface in response to the translated high-level software commands. For example, a high-level command issued by the interactive robotic software may direct the robot to move forward 10 centimeters. To direct the robot to move forward 10 centimeters, the first interface transmits this command or instruction to the Robot Control Interface, which translates the “move forward 10 cm” command into, for example, “turn two motors 10 times.” The motor commands are sent through the Robot Control Interface to the robot via, e.g., a wireless connection. In response to receiving the motor commands, the robot then executes the command.

The first interface receives sensor data collected by the robot from the Robot Control Interface and translates the sensor data to a form the interactive robotic software application is capable of understanding and evaluating. The Robot Control Interface comprises robot control software, memory and processing power required for running robot control software, where the Robot Control Interface receives the high-level software commands from the first interface and converts the commands to commands for robot control and sends the robot control commands to the second interface and receives sensor data from the second interface and forwards it to the first interface. The second interface also sends data collected by the sensors to the Robot Control Interface.

In another embodiment, the present invention is directed to a method for reconfiguring a conventional, autonomous robot using an interactive robotic software application. The method includes interfacing robot control software to a Robot Operating System to enable communication between the robot control software and the interactive robotic software application and interfacing the robot control software to an interface that includes hardware and software to enable communication between the robot control software and a robot.

Yet another embodiment of the invention is directed to a method for reconfiguring a conventional, autonomous robot using an interactive robotic software application. The method of this embodiment comprises receiving high-level commands from an interactive robotic software application, translating the high-level commands from the interactive robotic software application to a form that can be understood by robot control software such as robot control commands and transmitting the robot control commands to a robot. The method of this embodiment also includes the robot receiving the robot control commands from an interface with robot control software, processes the robot control commands, transmits the robot control commands to appropriate mechanisms of the robot to make the robot move.

The method of this embodiment also includes transmitting sensor data collected by the robot to an interface with robot control software, transmitting sensor data collected by the robot from the interface with robot control software to the interface that includes software and translating the sensor data to a form that can be understood by an interactive robotic software application.

In a first embodiment, the system of the present invention is configured to be used with multimedia software, although it is not limited in that way, that includes some or all of the following capabilities, namely, text, graphics, animation, audio, still images or video, and that provides a high degree of user control and interactivity, such as video game software and multimedia courseware used for training and simulation applications. The system of the present invention is configured to be used with devices that contain processing power similar to or on the order of that found in a personal computer including, but not limited to, devices for home electronics and communication such as video game consoles, handheld video game devices, personal digital assistants, cell phones, DVD players, TIVO®, personal computers, and distributed processing power via the Internet.

Within the field of robotics, the invention is configured to be used with simple robot mechanisms comprised of sensors, actuators, drive motors, and power to derive the economic benefit of the reconfiguration of the robot but the system of the invention can also be used with conventional, autonomous robots. The invention can be used with robots developed for any application including, but not limited to, robots designed for industrial, service, entertainment, education, and toy applications.

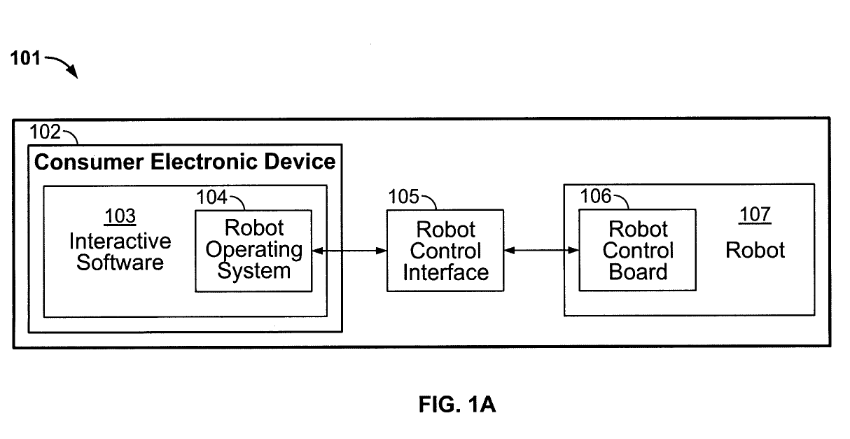

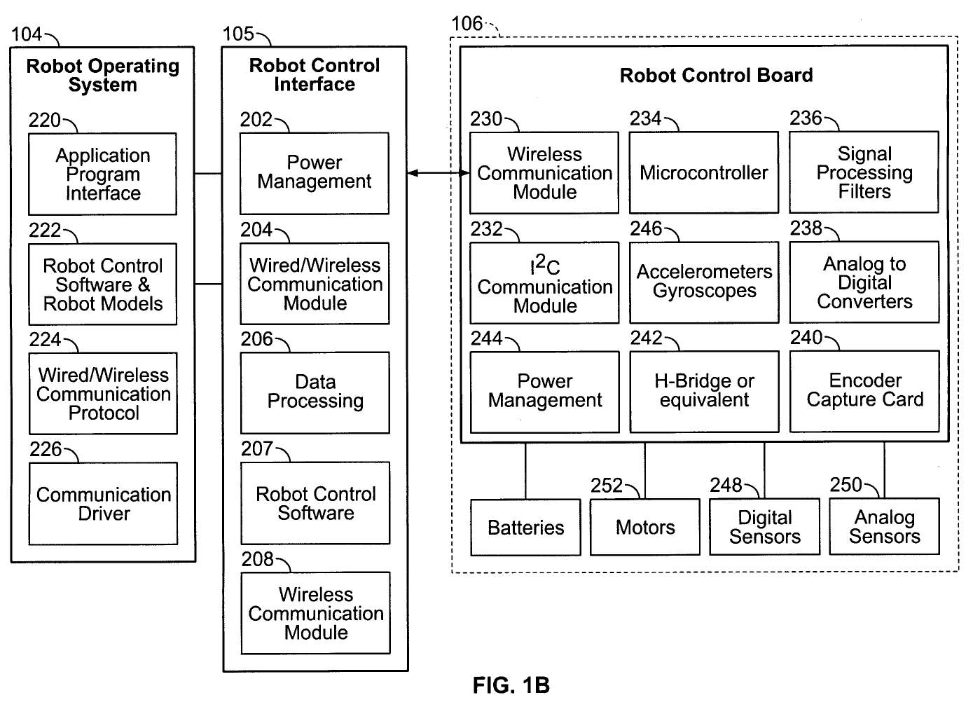

FIG. 1A is a simplified illustration of a system 101 in accordance with some embodiments of the present invention. As shown in FIG. 1A, the system of the present invention 101 includes a consumer electronic device 102 and a robot 107. The system may include multiple hardware and/or software interfaces—e.g., a Robot Operating System 104, a Robot Control Interface 105, and a Robot Control Board 106. For example, the consumer electronic device 102 includes interactive software 103 and Robot Operating System 104. The interfaces work in concert to create a system for reconfiguring a conventional, autonomous robot and for enabling interactive robotic applications to connect the interactive software 103, the consumer electronic device 102 that the software 103 is implemented on, and the robot 107.

It should be noted that the system of the present invention 101 may be used with any suitable platform (e.g., a personal computer (PC), a mainframe computer, a dumb terminal, a wireless terminal, a portable telephone, a portable computer, a palmtop computer, a personal digital assistant (PDA), a combined cellular phone and PDA, etc.) to provide such features.

Although a single computer may be used, the system according to one or more embodiments of the present invention is optionally suitably equipped with a multitude or combination of processors or storage devices. For example, the computer may be replaced by, or combined with, any suitable processing system operative in accordance with the concepts of the embodiments of the present invention, including sophisticated calculators, hand held, laptop/notebook, mini, mainframe and super computers, as well as processing system network combinations of the same.

The Robot Operating System 104, which comprises software that creates an interface between interactive software 103 and the Robot Control Interface 105, translates and communicates high-level commands from the interactive software 103 to the Robot Control Interface 105. For example, a high-level command issued by the interactive software 103 may direct the robot to move forward 10 centimeters. To direct the robot to move forward 10 centimeters, the interface transmits this command or instruction to the Robot Control Interface 105, which translates the “move forward 10 cm” command into, for example, “turn two motors 10 times.” The motor commands are sent through the Robot Control Interface 105 to the robot. In response to receiving the motor commands, the robot then executes the command.

As seen in the exemplary embodiment of FIG. 1A, the Robot Operating System 104 is shown as part of the interactive software code 103. However, it should be noted that all or a portion of the Robot Operating System 104 may reside on other parts of the system, such as, for example, the Robot Control Interface 105. The interactive software 103 is shown in a consumer electronic device 102. It should be understood by those skilled in the art that there are many ways to configure the Robot Operating System 104 and the software interactive code 103, including, without limitation, as illustrated in FIG. 1A.

The Robot Operating System 104 may communicate with the Robot Control Interface 105 using multiple approaches. When the software is loaded onto a consumer electronic device 102 that has suitable processing power (e.g., a personal computer), it may be downloaded to the device's memory (e.g., the random access memory and processor of the main circuit board) of the device 102. In some embodiments, the Robot Control Interface 105 may communicate with the software on the main circuit board via a physical connection to the device 102, e.g., a cable, or it may alternatively be on the main circuit board and would communicate via the circuitry interconnections. Alternatively, the Robot Control Interface 105 may communicate with the software on the main circuit board via a wireless connection (e.g., Bluetooth, a wireless modem, etc.) to the device 102.

In some embodiments, the Robot Operating System 104 also receives sensor data that is collected by the robot from the Robot Control Interface 105 and translates the sensor data to a format that the interactive software 103 is capable of understanding and evaluating. For example, an accelerometer onboard the robot measures the direction of gravity. This information may be transmitted wirelessly to the Robot Control Interface, which, in turn, transmits the information to the Robot Operating System 104. The Robot Operating System 104 may use the information to determine the position of the ground relative to the robot and to navigate the robot.

The Robot Control Interface 105 is generally comprised of hardware and software that enables communication between the Robot Operating System 104 and the Robot Control Board 106. It is also comprised of robot control software and the memory and processing power required to run robot control software. The Robot Control Interface 105 receives the high-level commands from the interactive software 103 via the Robot Operating System 104, converts them into specific commands for controlling the robot and, in turn, sends those commands to the Robot Control Board 106 via radio frequency or any other suitable method of wireless communication including but not limited to wireless LAN, Bluetooth or other methods for wireless communication that may be developed in the future. The Robot Control Interface 105 also receives sensor data from the Robot Control Board 106 and forwards it to the Robot Operating System 104. The Robot Control Interface 105 may take different forms depending on, for example, the type of device 102 that it is interfacing to robot 107. For example, the Robot Control Interface 105 may be a standalone box that plugs in to the device 102 via an adapter cord or a wireless link, it may be a circuit board that is fitted into an expansion slot of the device 102, or it may be a circuit board that is built into the device 102. These exemplary forms for the Robot Control Interface 105 are examples as it should be well understood by those skilled in the art that it could take other forms.

The Robot Control Board 106 is generally comprised of hardware and software that provides wireless communication between the robot 107 and the Robot Control Interface 105. The Robot Control Board 106 receives robot control commands from the Robot Control Interface 105, causing the robot mechanisms, e.g., the actuators and drive motors, to behave in a manner consistent with the interactive software 103. For example, Robot Control Interface 105 may transmit instructions to Robot Control Board 106 that drives particular actuators and motors in response to receiving the instructions. The Robot Control Board 106 also sends data collected by the sensors to the Robot Control Interface 105. The Robot Control Board 106 is preferably a circuit board that will be part of the electrical, mechanical and software systems of the robot 107.

FIG. 1B is a detailed example of the robot operating system, the robot control interface, and the robot control board of FIG. 1A that may be used in accordance with some embodiments of the present invention. Referring now to the configuration of each hardware and software interface in the system of the present invention 101, the Robot Operating System 104 generally includes software libraries comprised of, for example, an application program interface (API) 220 to the interactive software, robot control software and robot models 222, a wired/wireless communication protocol 224 and a communication driver 226. The Robot Operating System 104 and the interactive software (not shown) may lie along side of each other and may, for example, both be on a CD-ROM. It should be noted that portions of the system may be provided in any appropriate electronic format, including, for example, provided over a communication line as electronic signals, provided on CD and/or DVD, provided on optical disk memory, etc.

In some embodiments, the API 220 may be provided to make robotic implementation transparent to developers who currently use physics engines to develop interactive software. The API 220 may be a set of software function calls or commands that developers can use to write interactive robotic application software. More particularly, the API 220 may provide the developer with the ability to select commands for robot control that will be appropriate on the outbound and inbound part of the communication loop or in other words from commands in the interactive software to the robot and from the robot to the interactive software, where the same commands will be used to interpret sensory data received from the robot. The commands for robot control in the API 220 may be similar to commands developers currently use to communicate to physics engines used to develop application software. In another suitable embodiment, the only distribution to the user or the developer may be a Graphical User Interface which allows the user or the developer to interact with the application resident at, for example, a server.

The robot control software and robot models 222 implemented in the Robot Operating System 104 may be similar to that of the API 220 from the perspective of the software developer's ability to create and customize software for interactive robotic applications. The robot control software and robot models 222 in the Robot Operating System 104 generally are a description (e.g., a mathematical description) of the robot's physical characteristics, its environment, the expected interaction between the robot and its environment, and the available sensor information so that the information received from the robot may be interpreted correctly. The description of those entities is generally necessary to correctly control the robot and interpret its sensory information. The robot models 222 may further be understood as a collection of parameters of the robot and its configuration that describe, for example, how many motors, how many wheels, the size of the wheels, what appendages and linkages exist, what is the range of motion, what is the total robot mass and what are its dimensions.

The wired or wireless communication protocol 224 is code that describes the information being sent back and forth between the Robot Operating System 104 and the Robot Control Interface 105. The wired/wireless communication protocol 224 is a description of the order and of the identity of each information packet being sent over the wired communication link. The same protocol or order of the information applies when closing the loop or, in other words, when information is sent from the Robot Control Interface 105 to the Robot Operating System 104. The order of the information is generally a convention set by the developer.

The communication driver 226 is code that interfaces between the software in the Robot Operating System and the hardware of the device that is running the software. It receives communication commands from the software and it is responsible for channeling the information through the wired/wireless communication link to the Robot Control Interface 105.

In some embodiments, the Robot Control Interface 105 may include a power management module 202, a first communication module 204 that is wired and/or wireless, a data processing module 206 and a second communication module 208 that is wireless.

In some embodiments, the power management module 202 generally comprises electronic components and/or circuitry that regulates the power delivered to the Robot Control Interface 105 and, in turn, delivers the power to the other electronic components that form the Robot Control Interface 105. It should be noted that the source of the power for the Robot Control Interface 105 is the device that runs the software but, alternatively, the power may be from a separate plug that is used to get power from an outlet.

The first communication module 204, as shown in FIG. 1B, may be a device that receives and transmits information between the Robot Control Interface 105 and the Robot Operating System 104. The first communication module 204 may be configured for wired and/or wireless communication so that it has the capability to communicate with both wired and wireless devices that run software.

As shown in FIG. 1B, the data processing module 206 is a microcontroller or electronic chip that interprets the software commands received from the wired/wireless communication module and translates the information into robot commands and then, in turn, sends the robot commands to the wireless communication module. The data processing module 206 is capable of performing computations, such as, for example, interpreting distance so that a command in the software to move a robot forward ten centimeters is computed to spin the motors ten times. This computational ability is provided because a robot may not understand what it means to move forward ten centimeters, while a software developer generally does not care or understand how many times the motor is required to spin in order for the robot to move forward ten centimeter, but cares that the robot moves forward ten centimeters.

Also shown in FIG. 1B, the wireless communication module 208 is a chip that on the outbound part of the communication loop transmits the robot control commands from the data processing module to the Robot Control Board 106 and on the inbound part of the communication loop will receive sensory information from the Robot Control Board 106. The inbound part of the loop is completed when the sensory information is sent upstream from the wireless communication module to the data processing module and then, in turn, to the wired/wireless communication module that transmits the sensory data to the Robot Operating System 104.

In some embodiments, Robot Control Interface 105 may be a standalone box or board that contains all of the mentioned components. In addition, when Robot Control Interface 105 is a standalone box or board, it may also include a more powerful data processing module that has the computational power of a central processing unit of a CPU in addition to having the memory support required to run the processes of the CPU. The data processing module 206 may be responsible for not only carrying the information from the Robot Operating System 104 to the Robot Control Board 210 but it may also have the capability to interpret the commands sent by the interactive software through the API 220 into robot control commands. This interpretation is done through models 222 of the robot, of the world and of the behavior of the robots in the world. In the above-mentioned example of the Robot Control Interface 105, the robot models 222 also remain on the Robot Operating System 104.

In some embodiments, the Robot Control Board 106 comprises electronic circuitry that sits on a board that powers and controls the robot. As shown in FIG. 1B, the Robot Control Board 106 may include a wireless communication module 230, an I²C communication module 232, a microcontroller 234, signal processing filters 236, analog to digital converters 238, an encoder capture card 240, an H-bridge or equivalent 242, power management 244, accelerometers and gyroscopes 246, and input/output ports and pins (not shown). The Robot Control Board 106 may receive and transmit information from portions of the robot, such as digital sensors 248, analog sensors 250, and motors 252. It should be noted that any other suitable mechanical or electrical component (e.g., sensors, actuators, drive, power, etc.) of the robot may be controlled by the Robot Control Board 106.

The wireless communication module 230 handles wireless communication between the Robot Control Board 106 and the Robot Control Interface 105. For example, instructions sent over the wireless communication module 230 from the Robot Control Interface 105 to the Robot Control Board 106 may specify the number of rotations that the motor shafts need to complete, or the input/output port that needs to be powered and for how long it needs to be powered in order to light an LED or send an audible signal. The wireless communication module 230 may also transmit information relating to the robot to the Robot Control Interface 105 such as, for example, data from one of the sensors 248 and 250.

The IC communication module 232 handles the communication between the components attached to the Robot Control Board 106 and the board 106 itself.

Generally, the microcontroller 234 1) manages the communication bus linking the different chips installed on the board 106; 2) controls the velocity of the motors 252 so that they spin at the desired speed; 3) makes it possible to automatically close a local loop between sensors 248 and 250 and motors 252 in order to provide a reactive, quick response based on simple laws or control rules; and 4) collects the information provided by the sensors 248 and 250 and sends this information to the Robot Control Interface 105 through the wireless communication module 230.

The signal processing filters 236 generally comprise electronic components that reduce the noise contained in sensor data. Sensors 248 and 250 output a continuous stream of data and information is often cluttered in additional sensor output that does not contain information. This is called noise and the filters 236 seek to reduce it.

The analog to digital converters 238 are electronic components that take as input the continuous stream of data from the sensors and then digitize this data, passing it to the electronic components for processing.

The encoder capture card 240 is a chip that connects to the encoder which is a device mounted on the motor of the robot that counts the number of shaft rotations. The encoder capture card 240 transmits this information to the microprocessor 234. Using the encoder capture card 240, the Robot Control Board 106 knows precisely the motor's angle of rotation. It may be used to close the Proportional, Integral, Derivative (PID) control loop. The encoder capture card 240 may be present on the board or absent from the board. The decision is generally based on the economics of the robot. Alternatively, potentiometers may be used to close the PID control loop and control motor rotation.

The H-bridge or equivalent 242 is sets of electronic components on the board that deliver power from the batteries to the motors of the robot. The microcontroller controls the gate on the H-bridge 242 so that more or less power is delivered to the motors at will. The microcontroller may also direct the H-bridge 242 to control the motors to, for example, move forward, move backwards, rotate, and stop. In some embodiments, when driving low-power motors (e.g., hobby servos), the H-bridge 242 may be by-passed and the motors may be powered directly from the Robot Control Board 106.

Power management 244 is an electronic device that draws power from the on-board batteries, including, but not limited to, lithium ion batteries or lithium polymer batters or nickel metal hydride batteries. The power management 244 unit draws the power from these batteries and distributes some of the power to the board in order to power individual chips and delivers the rest of the power to the motors as regulated by the H-bridge to the motors.

In some embodiments, accelerometers and gyroscopes 246, which are sets of micro-electronic mechanical systems (MEMS) sensors that measure the acceleration of the Robot Control Board 106 in three dimensions as well as measure the rate of rotation of the Robot Control Board 106 in three dimensions, may be implemented on the Robot Control Board 106. The acceleration of the Robot Control Board 106 is measured because the board has become a structural part of the robot and the motion of the robot means the motion of the board. It should be noted that accelerometers and gyroscopes 246 are not necessary on the Robot Control Board 106 and may not be included due to economics of the robot.

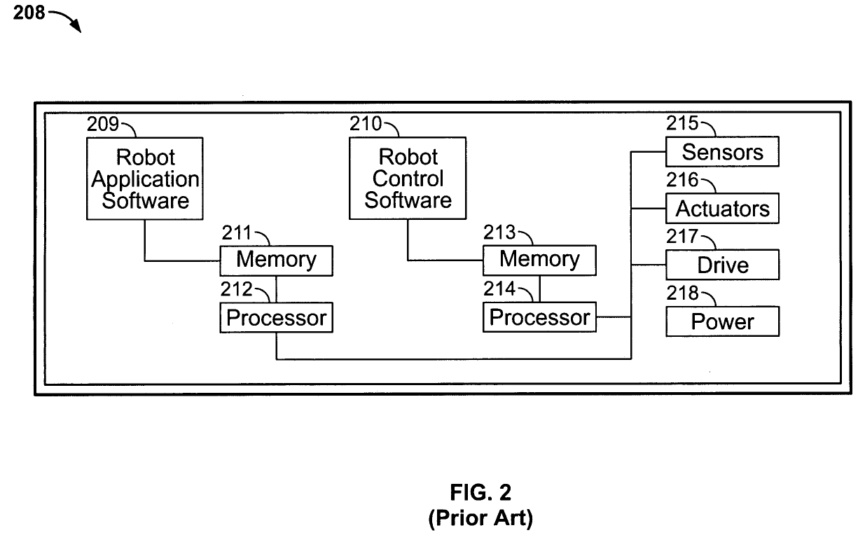

As shown in FIG. 2, there is illustrated in block diagram form, a conventional, autonomous robot 208, which includes a number of elements that in cooperation form a robot. The robot 208 includes robot application software 209 that defines the purpose of the robot 208 and directs how the robot 208 accomplishes that purpose. The robot 208 also includes robot control software 210 that controls the robot 208 and sensors 215, actuators 216, and drive 217. In addition, the robot 208 includes memory 211 and 213 to store robot application software 209 and robot control software 210 and to save information gathered by the sensors 215. Robot 208 also includes processors 212 and 214 that run the robot application software 209 and the robot control software 210. The sensors 215 interface between the robot 208 and its environment via vision, touch, hearing, and telemetry. The actuators 216 allow the robot 208 to perform tasks and may include, e.g., grippers and other mechanisms. The drive 217 provides the mobility in the robot 208, including, e.g., wheels, legs, tracks and the motors that move it. The robot 208 also includes power 218, typically batteries to supply the requisite electrical energy for the electronics and motors.

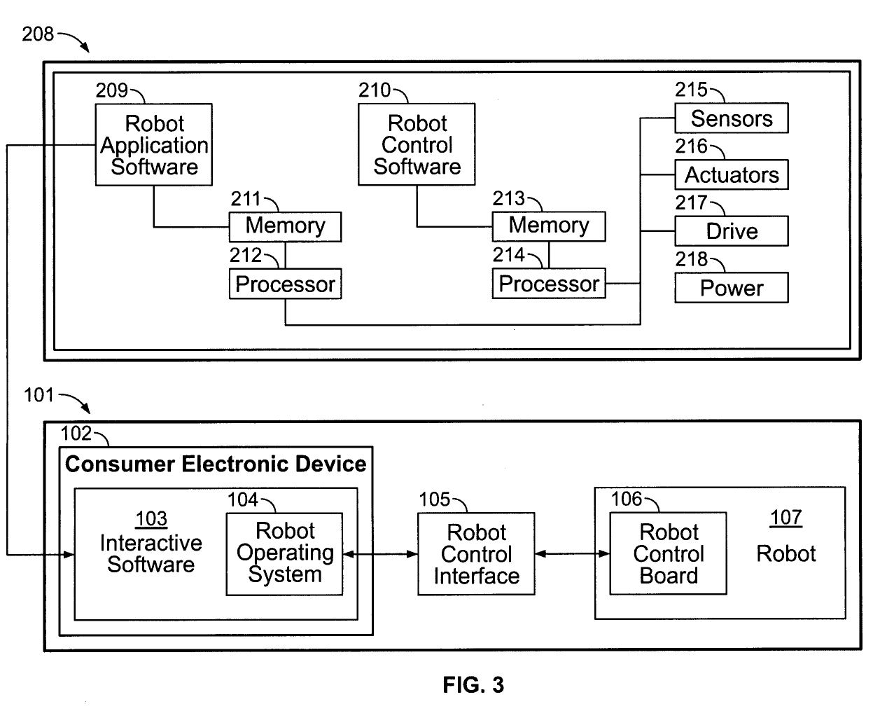

Now that conventional, autonomous, mobile robots have been explained in FIG. 2, it will next be explained how the present invention enables the conventional, autonomous robot to be reconfigured. It should be understood, however, that the present invention will, of course, work with conventional, autonomous robots without requiring the robots to be physically reconfigured. The hardware and software interface of the System 101 remove the need for the conventional, autonomous, mobile robot to have (1) robot application software, (2) robot control software, (3) processing power for the robot application software and the robot control software, and (4) memory for the robot application software, the robot control software, and the information collected by the sensors. FIGS. 3-6 depict how those functions (1-4) are distributed to other devices and software in the System 101.

FIG. 3 illustrates that the function of the robot application software 209 in the conventional, autonomous robot 208 will be assumed in the System 101 by the interactive software 103, which will replace the need for the robot application software 209, define the purpose of the robot and direct how the robot accomplishes that purpose. By removing the robot application software from the configuration of the conventional, autonomous robot, software developers will be able to write applications (e.g., video games) that have robots as part of the game without the need for understanding robotics.

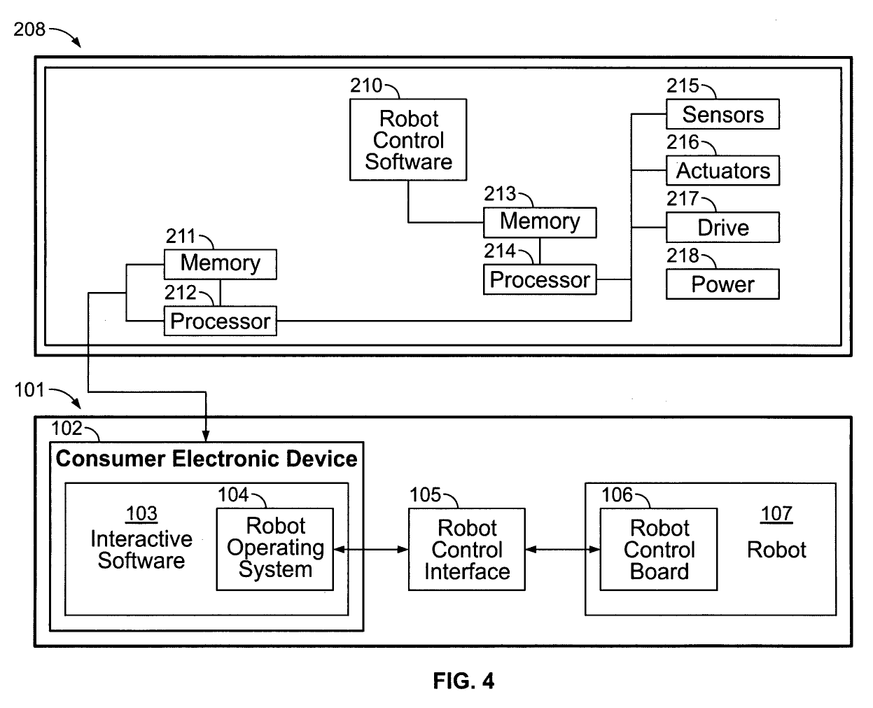

FIG. 4 illustrates that the memory 211 and processor 212 formerly required to run the robot application software 209 on the conventional, autonomous robot 208 is replaced in the System 101 by the memory and the processing power of the consumer electronic device 102 that the interactive software 103 runs on. As a result, the processing power of the robot 107 is no longer a limiting factor for interactivity.

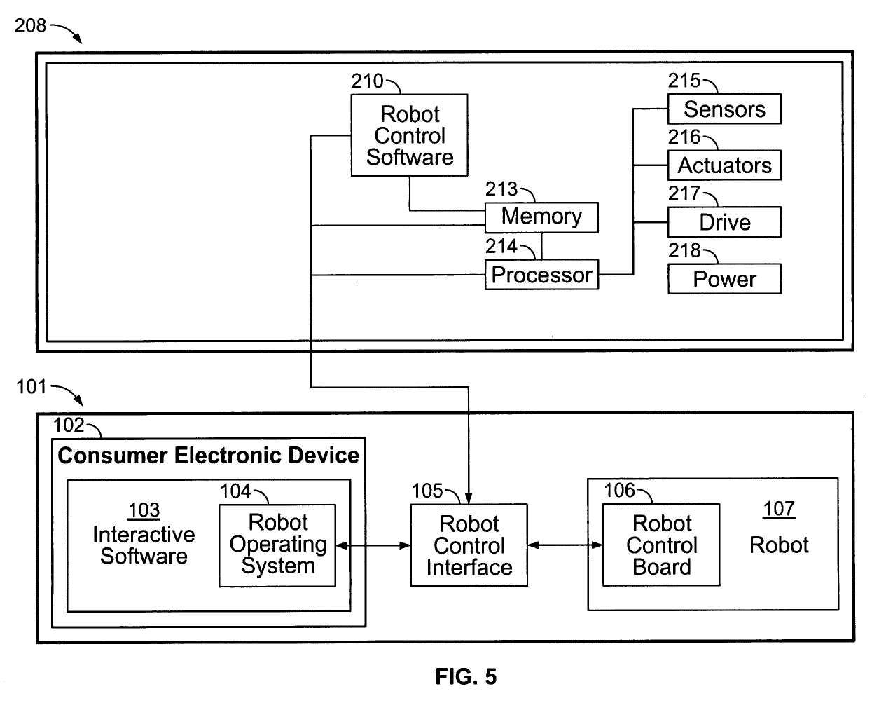

FIG. 5 depicts that the functions of the robot operating software 210, which controls the operation of the robot, and the memory 213 and processor 214 formerly required for the robot control software 210, are performed by the Robot Control Interface 105 in the System 101. By allowing the robot controls to be carried out by Robot Control Interface 105, there is no need to develop robot control software 210 independently for all robot applications.

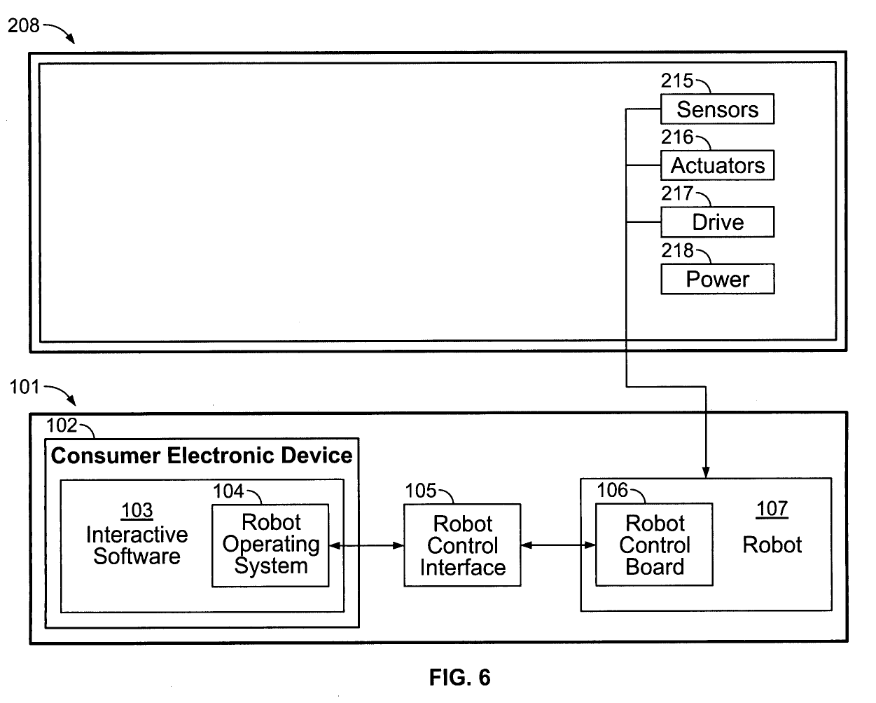

FIG. 6 illustrates an embodiment where the mechanical aspects of the robot—e.g., the sensors 215, actuators 216, drive 217 and power 218—are all that remain as a part of the robot 107 in the new configuration of the System 101.

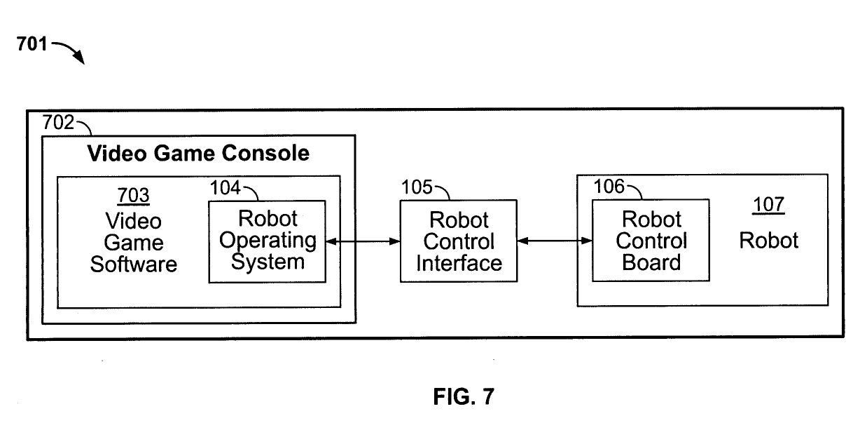

FIG. 7 shows an exemplary embodiment of the system of the present invention 101 where the consumer electronic device 102 of FIG. 1A is a video game console 702 and the interactive software 103 of FIG. 1A is video game software 703. The mechanical aspects of the robot 208—the sensors, actuators, drive and power—are all that need to remain as a part of the robot 107 in the new configuration so that, when combined with video game software 703, the Robot Operating System 104, the Robot Control Interface 105 and the Robot Control Board 106, simple, affordable robot mechanisms can display complex, interactive behaviors as controlled by the action and story of the video game.

The hardware and software interfaces of the System 701 form a communication and control loop between the video game software 703 and the robot 107. In response to the receipt of input from a user, the video game software 703 sends high-level game commands to the Robot Control Interface 105 via the Robot Operating System 104, which translates the commands to a format that can be recognized by the Robot Control Interface 105 before sending. The Robot Control Interface 105, in turn, converts the high-level commands from the Robot Operating System 104 into robot control commands and sends those commands to the Robot Control Board 106, which causes the mechanisms of the robot 107, e.g., the actuators and drive motors, to behave in a manner that is consistent with the story in the video game, e.g., kick, fight, race, or explore. The Robot Control Board 106 sends data collected by the robot sensors to the Robot Control Interface 105. The Robot Control Interface 105 then sends that data to the Robot Operating System 104, which translates the data to a format that is recognized by the video game software 703. The video game software 703 evaluates the data and sends new commands to the robot 107 via the method just described.

Although the invention has been described and illustrated in the foregoing exemplary embodiments, it is understood that the present disclosure has been made only by way of example, and that numerous changes in the details of construction and combination and arrangement of processes and equipment may be made without departing from the spirit and scope of the invention.

It will also be understood that the detailed description herein may be presented in terms of program procedures executed on a computer or network of computers. These procedural descriptions and representations are the means used by those skilled in the art to most effectively convey the substance of their work to others skilled in the art.

A procedure is here, and generally, conceived to be a self-consistent sequence of steps leading to a desired result. These steps are those requiring physical manipulations of physical quantities. Usually, though not necessarily, these quantities take the form of electrical or magnetic signals capable of being stored, transferred, combined, compared and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to these quantities.

Further, the manipulations performed are often referred to in terms, such as adding or comparing, which are commonly associated with mental operations performed by a human operator. No such capability of a human operator is necessary, or desirable in most cases, in any of the operations described herein which form part of the present invention; the operations are machine operations. Useful machines for performing the operation of the present invention include general purpose digital computers or similar devices.

The present invention also relates to apparatus for performing these operations. This apparatus may be specially constructed for the required purpose or it may comprise a general purpose computer as selectively activated or reconfigured by a computer program stored in the computer. The procedures presented herein are not inherently related to a particular computer or other apparatus. Various general purpose machines may be used with programs written in accordance with the teachings herein, or it may prove more convenient to construct more specialized apparatus to perform the required method steps. The required structure for a variety of these machines will appear from the description given.

The system according to the invention may include a general purpose computer, or a specially programmed special purpose computer. The user may interact with the system via e.g., a personal computer or over PDA, e.g., the Internet an Intranet, etc. Either of these may be implemented as a distributed computer system rather than a single computer. Similarly, the communications link may be a dedicated link, a modem over a POTS line, the Internet and/or any other method of communicating between computers and/or users. Moreover, the processing could be controlled by a software program on one or more computer systems or processors, or could even be partially or wholly implemented in hardware.

Although a single computer may be used, the system according to one or more embodiments of the invention is optionally suitably equipped with a multitude or combination of processors or storage devices. For example, the computer may be replaced by, or combined with, any suitable processing system operative in accordance with the concepts of embodiments of the present invention, including sophisticated calculators, hand held, laptop/notebook, mini, mainframe and super computers, as well as processing system network combinations of the same. Further, portions of the system may be provided in any appropriate electronic format, including, for example, provided over a communication line as electronic signals, provided on CD and/or DVD, provided on optical disk memory, etc.

Any presently available or future developed computer software language and/or hardware components can be employed in such embodiments of the present invention. For example, at least some of the functionality mentioned above could be implemented using Visual Basic, C, C++ or any assembly language appropriate in view of the processor being used. It could also be written in an object oriented and/or interpretive environment such as Java and transported to multiple destinations to various users.

It is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Although the present invention has been described and illustrated in the foregoing exemplary embodiments, it is understood that the present disclosure has been made only by way of example, and that numerous changes in the details of implementation of the invention may be made without departing from the spirit and scope of the invention, which is limited only by the claims which follow.

1. A system for interacting with a robot, the system comprising:
a processing device having a first interface that is in communication with a robot control interface, the processing device comprising:
memory;
a processor at least partially executing an interactive robotic application that is configured to transmit an instruction for the robot to the first interface; and
the first interface that is configured to:
receive an instruction for the robot from the interactive robotic application; and
transmit the instruction from the first interface to the robot control interface in response to receiving the instruction;
the robot control interface that is in communication with the first interface and a second interface associated with the robot, the robot control interface comprising:
memory;
a communication module; and
a processor at least partially executing a robot control application that is configured to:
receive the instruction from the first interface;
convert the instruction to at least one robot control command; and
transmit the at least one robot control command to the second interface associated with the robot using the communication module;
the robot having the second interface, the second interface being in communication with the robot control interface, the robot comprising:
a sensor that transmits sensor data to the second interface;
a motor; and
the second interface that has a wireless communication module, the second interface is configured to:
transmit sensor data to the robot control interface using the wireless communication module;
receive the at least one robot control command from the robot control interface using the wireless communication module; and
direct at least one of the motor and the sensor to perform a function responsive to the at least one robot control command.

2. The system of claim 1, wherein the sensor associated with the robot transmits sensor data to the second interface and wherein the robot control application on the robot control interface is further configured to receive the sensor data from the second interface.

3. The system of claim 2, wherein the robot control application on the robot control interface is further configured to determine the at least one robot control command based at least in part on the received sensor data.

4. The system of claim 2, wherein the robot control application on the robot control interface is further configured to convert the sensor data to another format and transmit the sensor data in the another format to the first interface for use by the interactive robotic application.

5. The system of claim 1, wherein the robot control application is at least partially executed on the robot and wherein the robot further comprises robot models that describe characteristics of the robot and its environment.

6. The system of claim 1, wherein the robot control interface further comprises robot models that describe characteristics of the robot and its environment.

7. The system of claim 1, wherein the first interface further comprises robot models that describe characteristics of the robot and its environment.

8. The system of claim 1, wherein the processing device having the first interface and the robot control interface are in communication using a wired link.

9. The system of claim 1, wherein the processing device having the first interface and the robot control interface are in communication using a wireless communication link.

10. The system of claim 1, wherein the processing device, the robot control interface, and the robot are physically separate from each other.

11. The system of claim 1, wherein the first interface, the robot control interface, and the second interface substantially minimize the amount of circuitry required on the robot and the processing device.

12. The system of claim 1, wherein the robot control interface resides on the processing device.

13. The system of claim 1, wherein the robot control interface and the first interface reside on the processing device.

14. The system of claim 1, wherein the robot control interface is located outside of the processing device.

15. The system of claim 1, wherein the second interface has an input port and an output port.

16. A method for interacting with a robot, the method comprising:
receiving an instruction for the robot from an interactive robotic application through a first interface;
determining whether the instruction is comprehensible to the robot;
to the extent the instruction is not comprehensible to the robot, converting the instruction to at least one robot control command, wherein the at least one robot control command is comprehensible by the robot;
wirelessly transmitting the at least one robot control command to a second interface that directs at least one of a motor and a sensor associated with the robot to perform a function based at least in part on the at least one robot control command;
receiving data associated with the sensor on the robot from the second interface, wherein the second interface is in communication with the robot; and
transmitting the data associated with the sensor to interactive robotic application through the first interface for processing using the interactive robotic application.

17. The method of claim 16, wherein the second interface is a robot control board.

18. The method of claim 16, further comprising converting the data from the second interface to another format and transmitting the data in the another format to the first interface for use by an interactive robotic application.

19. The method of claim 16, wherein the step of converting the instruction further comprises receiving data from the second interface and determining the at least one robot control command based at least in part on the received data.

20. A robot control interface for interacting between a first interface associated with an electronic device and a second interface associated with a robot, the interface comprising:
memory;
a communication module; and
a processor at least partially executing a robot control application that is configured to:
receive the instruction from the first interface associated with electronic device that is executing an interactive robotic application, wherein the instruction is not comprehensible by the robot;
convert the instruction from the first interface to at least one robot control command, wherein the at least one robot control command is not comprehensible by the interactive robotic application;
transmit the at least one robot control command to the second interface associated with the robot using the communication module, wherein the robot executes the at least one robot control command by directing at least one of a sensor and a motor on the robot to perform a function responsive to the instruction received from the first interface;
receive data associated with the at least one of the sensor and the motor from the second interface; and
transmit the received data to the first interface for processing by the interactive robotic application.

21. The system of claim 20, wherein the interface device substantially minimizes the amount of circuitry required on the robot and the electronic device.

22. A robot control interface for interacting with a robot, wherein the robot control interface is in communication with a first interface, the first interface is in communication with a processing device that has memory and a processor, the processor on the processing device at least partially executes an interactive robotic application, the robot control interface at least partially executing a robot control application that is configured to:
receive an instruction for the robot from the interactive robotic application through the first interface;
determine whether the instruction is comprehensible by the robot;
to the extent the instruction is not comprehensible by the robot, convert the instruction to at least one robot control command;
transmit the at least one robot control command to a second interface associated with the robot, wherein the robot executes the at least one robot control command to perform a function responsive to the instruction; and
receive data from the second interface relating to a sensor on the robot.

23. The robot control interface of claim 22, wherein the robot control application is further configured to transmit the received data to the first interface for processing.

24. A system for interacting with a robot, the system comprising:
a processing device having a first interface and a robot control interface, wherein the first interface is in communication with the robot control interface, the processing device comprising:
memory;
a processor at least partially executing an interactive robotic application that is configured to transmit an instruction for the robot to the first interface;
the first interface that is configured to receive the instruction for the robot from the interactive robotic application and transmit the instruction to the robot control interface in response to receiving the instruction; and
the robot control interface that is configured to:
convert the instruction to at least one robot control command;
transmit the at least one robot control command to a second interface associated with the robot using a communication module; and
receive data relating to a sensor on the robot from the second interface;
the robot having the second interface, the second interface being in communication with the robot control interface, the robot comprising:
the sensor that transmits sensor data to the second interface;
a motor; and
the second interface that has a wireless communication module, the second interface is configured to:
transmit sensor data to the robot control interface using the wireless communication module;
receive the at least one robot control command from the robot control interface using the wireless communication module; and
direct at least one of the motor and the sensor to perform a function responsive to the at least one robot control command.

25. A system for interacting with a robot, the system comprising:
a processing device, the processing device comprising memory and a processor, wherein the processor at least partially executes an interactive robotic application;
a robot control interface comprising:
a first interface that is electrically connected to the robot control interface, wherein the first interface is in communication with the processing device that is at least partially executing the interactive robotic application;
memory;
a communication module; and
a processor at least partially executing a robot control application that is configured to:
receive an instruction for the robot from the first interface, wherein the first interface received the instruction from the interactive robotic application; and
to the extent the instruction is not comprehensible by the robot, convert the instruction to at least one robot control command; and
transmit the at least one robot control command to a second interface of the robot using the communication module;
the robot having the second interface, the second interface being in communication with the robot control interface, the robot comprising:
a sensor that transmits sensor data to the second interface;
a motor; and
the second interface that has a wireless communication module, the second interface is configured to:
transmit sensor data to the robot control interface using the wireless communication module;
receive the at least one robot control command from the robot control interface using the wireless communication module; and
direct at least one of the motor and the sensor to perform a function responsive to the at least one robot control command.

26. A system for interacting with a robot, the system comprising:
a robot having at least one of a sensor, a motor, a power source, and an actuator; and
a robot control board coupled to the at least one of the sensor, the motor, the power source, and the actuator, wherein the robot control board has a wireless communication module and is configured to:
receive data from the at least one of the sensor, the motor, the power source, and the actuator;
use the wireless communication module to transmit the received data to a robot control interface for processing;
receive a robot control command for the robot through the wireless communication module from the robot control interface; and
execute the robot control command to perform a given function in response to receiving the robot control command.

27. A system for interacting with a robot, the system comprising:
an interface that is configured to:
receive an instruction for the robot from an interactive robotic application, wherein the interactive robotic application is generated using an application program interface and robot models;
transmit the instruction to a robot control interface in response to receiving the instruction, wherein the robot control interface is in communication with another interface associated with the robot and wherein the robot performs a function responsive to the instruction;
receive data associated with a sensor on the robot from the robot control interface; and
process the data using the interactive robotic application in response to receiving the data.
